(19) United States
(12) Patent Application Publication
(10) Pub. No.: US 2015/0359072 A1
(43) Pub. Date: Dec. 10, 2015

(54) PILING LIGHT

(71) Applicant: DIRECT RESULT GROUP, LLC, Lake Worth, FL (US)

(72) Inventors: David LAPORTA, Matawan, NJ (US); Bill PHILLIPS, Cincinnati, OH (US); Marcelo DEOLOVIERA, Boca Raton, FL (US)

(21) Appl. No.: 14/758,685

(22) PCT Filed: Dec. 30, 2013
(86) PCT No.: PCT/US13/78300

§ 371 Date: Jun. 30, 2015

Related U.S. Application Data
(60) Provisional application No. 61/747,652, filed on Dec. 31, 2012.

(51) Int. Cl. H05B 37/02; F21S 8/08; F21V 23/02; F21V 5/00; F21V 29/70; F21V 23/00; F21V 5/04; F21S 9/03

(52) U.S. Cl. CPC H05B 37/0227; F21V 5/048; F21S 8/088; F21S 9/037; F21V 5/008; F21V 29/70; F21V 23/003; F21V 23/02; H05B 37/0272; F21Y 2101/02

(57) ABSTRACT

An outdoor light includes an outer optical lens having a circumferential sidewall and an open top, the sidewall having an outer side and an inner side, with a plurality of circumferential ribs arranged on the outer side. A housing is mounted at the top of the outer optical lens having a bottom facing an inside of the outer optical lens and a top facing away from the outer optical lens. A control circuit is mounted in the housing. A light source is mounted at a bottom of the housing with an inner optical lens disposed between the light source and the outer optical lens, the inner optical lens having a substantially convex outer surface with a central depression.

### FIELD OF THE INVENTION

The present invention relates to outdoor lighting and more specifically to solar-powered piling lighting.

### BACKGROUND OF THE INVENTION

Outdoor lights are used for illuminating sidewalks and other walkways and are known in many configurations. Piling lights are a particular implementation of outdoor lighting that are used to illuminate a dock area surrounding a piling on which the light is mounted. Although the primary purpose of the lights is to illuminate walkways or pathways, the lights may also be arranged to provide an aesthetically pleasing design.

Solar-powered lights have the advantage of being standalone devices that do not require remote connections to a power source. Thus, they can be placed where they are required without regard to a power supply, except that they must be exposed to the sun.

A disadvantage of solar lighting is that the lights are wholly dependent on the stored energy from the sun and may not remain illuminated for an entire overnight period. This is especially true during late fall and winter seasons. Accordingly, the conflicting goals of energy efficiency and light output must be balanced.

Another disadvantage of solar lighting is that when an array of multiple lights are used in an area, each light may be exposed to different light conditions such that the lights do not turn on and off in unison. This can create areas that lack proper lighting during the transition period from day to night.

Yet a further disadvantage of solar lighting is that the heat generated by the solar panel during collection of sunlight can negatively affect the charging operation of the battery.

### SUMMARY OF THE INVENTION

An object of the invention is provide an outdoor light that provides proper illumination and solves the problems of the prior art.

The object is met by an embodiment of the invention having an outdoor light with an outer optical lens having a circumferential sidewall and an open top, the sidewall having an outer side and an inner side, with a plurality of circumferential ribs arranged on the outer side. The outdoor light further includes a housing mounted at the top of the outer optical lens having a bottom facing an inside of the outer optical lens and a top facing away from the outer optical lens. A control circuit is mounted in the housing and a light source is mounted at the bottom of the housing with an inner optical lens disposed between the light source and the outer optical lens, the inner optical lens having a substantially convex outer surface with a central depression. The shape of the inner lens ensures that the inner side of the sidewall is equally illuminated so that each of the circumferential ribs receives the same amount of lumens.

A cross-sectional shape of the outer surface of the inner optical lens is defined by a spline curve defining a convex curve. To achieve the outer surface of the lens, the convex curve is rotated about an axis with a peak of the convex curve being offset from the axis to form the central depression at the axis.

The circumferential ribs of the outer optical lens are arranged in at least three zones of the outer optical lens, each zone of the at least three zones irradiating light in a different direction than the others of the at least three zones.

According to an embodiment of the present invention, the at least three zones include a first zone directing light substantially in a horizontal direction, a second zone directing light in a direction between horizontal and the ground, and a third zone directing light to the ground in a predetermined perimeter surrounding the outdoor light. More specifically, the first zone directs light in the range +/−4 degrees from horizontal, the second zone directs light in a range from −4 degrees to the predetermined perimeter, and the third zone directs light within the predetermined perimeter. The predetermined perimeter is preferably a circle with a five foot radius.

According to another embodiment of the present invention, each of the circumferential ribs has a facet for directing the irradiated light, each facet beginning with a radius of curvature and ends with a radius of curvature, thereby facilitating manufacture and eliminating banding of irradiated light.

The outdoor light further includes a solar panel arranged at the top of the housing and a battery and the control circuit arranged inside the housing, with a first heat sink disposed between the solar panel and the housing. A mount or support for the piling light includes a base and at least three vertical brackets, wherein the first heat sink is connected to each of the vertical brackets, whereby heat generated by the solar panel and the housing is dissipated through the first heat sink and vertical brackets. In a further embodiment, a second heat sink is arranged between the light source and the housing, wherein the light source is mounted to the housing by the second heat sink.

According to an embodiment, the housing, the inner optical lens, and the outer optical lens form an integral assembly supported by the vertical brackets via the first heat sink.

The control circuit measures an amount of power obtained by the solar panel and stored by the battery in a predetermined period, i.e., 24 hours. The amount of power obtained is used to determine one of a turn on time of the light source, a turn off time of the light source, or an intensity of the light source. The control circuit further measures a length of a dark period from dusk until dawn. This information is used to determine how long the light source is required to be turned on and the control circuit controls an intensity of the light source based on the measured length and the measured amount of power so that the light stays illuminated for an entire night.

In yet another embodiment, the outdoor light includes a remote control circuit allowing a user to at least one of turn on the light source, turn off the light source, and to control the intensity of the light source.

The outdoor light may also include a wireless transceiver allowing communication with other outdoor lights. In this way, a plurality of outdoor lights can all be turned on simultaneously when one of the light receives a turn-on signal. The transceiver is connected to the control circuit.

### BRIEF DESCRIPTION OF THE DRAWINGS

In the drawings, where like reference characters denote similar elements throughout the several views:

FIG. 1 is a perspective view of a piling light according to an embodiment of the present invention;

FIG. 2 is a cross-sectional view of the piling light of FIG. 1;

FIG. 3A is a plan view of a top of an inner lens of the piling light of FIG. 1;

FIG. 3B is a cross-sectional view of the inner lens of FIG. 3A;

FIG. 4 is a schematic view of the inner lens of FIG. 3 with a light source, the lens being depicted upside-down;

FIG. 5 is a table of a dataset for the spline curve of the outer surface of the inner lens of FIG. 4;

FIG. 6 is a side view of the outer lens of the piling light of FIG. 1;

FIG. 7 is a detailed view of the ribs of the outer lens of FIG. 6;

FIG. 8 is a perspective view of the outer lens of FIG. 6;

FIG. 9 is an irradiance map taken five feet from an embodiment of the piling light of FIG. 1 without vertical ribs;

FIG. 10 is an irradiance map taken five feet from another embodiment of the piling light of FIG. 1 with vertical ribs;

FIG. 11 is an irradiance pattern of one zone of the piling lamp of FIG. 1;

FIG. 12 is a candela plot of the piling lamp of FIG. 1;

FIG. 13 is a flow diagram depicting an embodiment of the present invention; and

FIG. 14 is a flow diagram of another embodiment of the present invention.

### DETAILED DESCRIPTION OF THE PREFERRED EMBODIMENTS

The following describes a preferred embodiment of the present invention. Although particular mechanical connections such as threaded connections and/or threaded fasteners are shown and described, any known or hereafter developed fastening devices or methods such as, for example, adhesives, rivets, welds, friction fittings, or deformations may alternatively be used.

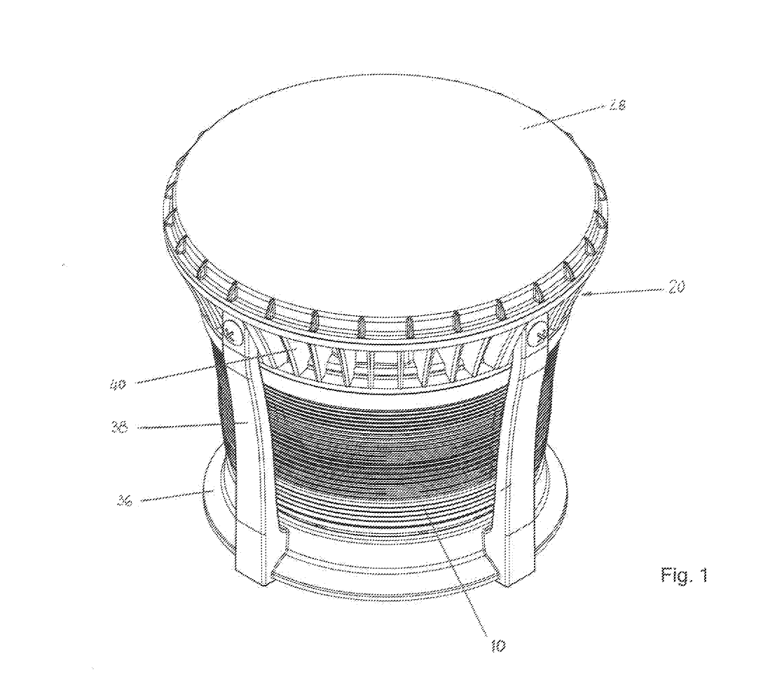

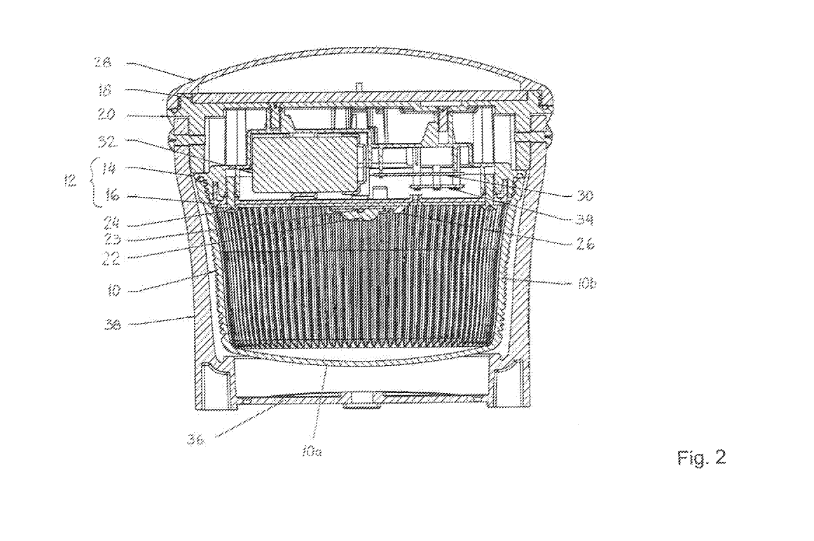

FIGS. 1 and 2 show a piling light according to an embodiment of the present invention. The piling light includes a housing 12 accommodating a battery 32, a main controller board 30 and, optionally, a remote controller board 34. The housing 12 includes a top housing 14 and a bottom housing 16. A bowl-shaped outer optical lens 10 having a bottom 10a and a circumferential sidewall 10b is mounted to the housing 12 by a threaded connection. The housing is preferably made of plastic. However, other known or hereafter developed suitable translucent materials may be used. Moreover, although separate circuit boards 30 and 34 are shown, the functions of both boards may be combined on a single board.

A light source 23 is mounted on the bottom of the housing 12 with an inner optical lens 22 mounted over the light source. According to a preferred embodiment, the light source 23 is an LED lamp. However, any known or hereafter developed light source may be used. The light source 23 is mounted on a light source board 26 disposed at the bottom of the housing 12. Although a light source board 26 is disclosed, the light source may also be mounted as a standalone element with the circuitry being arranged in the housing as a separate item or as part of the main controller board 30. An aluminum heat sink plate 24 is arranged between the light source 23 and the housing 12.

A solar panel 18 is arranged on top of the housing 12 with an aluminum heat sink 20 disposed between the solar panel 18 and the housing 12. A clear dome cover 28 is mounted over the solar panel 18. The aluminum heat sink 20 includes fins 40 along the outer circumference thereof for the purpose of dissipating heat. Although the heat sink plate 24 and the heat sink are made of aluminum in the preferred embodiment, other known or hereafter developed suitable heat sink materials may be used.

The outer optical lens 10, housing 12, aluminum heat sink 20, and the solar panel 18 are assembled as a unit that is supported by a support fixture including a base 36 and four aluminum brackets 38. The brackets 38 extend substantially vertically from the base 36 and the upper ends of the brackets 38 are connected to the aluminum heat sink 20 to support the assembly.

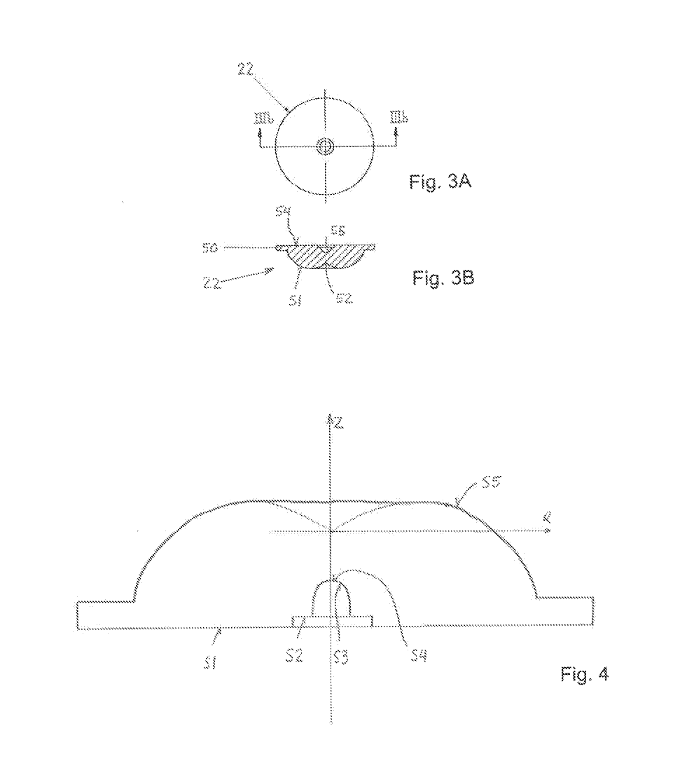

As shown in FIGS. 3a and 3b, the inner optical lens 22 includes a flange 50 with a back surface 54 which faces the housing 12 and a front surface 51 which faces the inside of the outer optical lens 10. A cavity 55 is arranged in the back surface 54 in which the light source 23 is inserted. In a preferred embodiment, the contour of the cavity 55 conforms to the shape of the light source 23. The front surface 51 is a substantially convex surface with a depression 52 or dimple in a center thereof. The shape of the front surface 51 ensures that the sidewall 10b is illuminated equally.

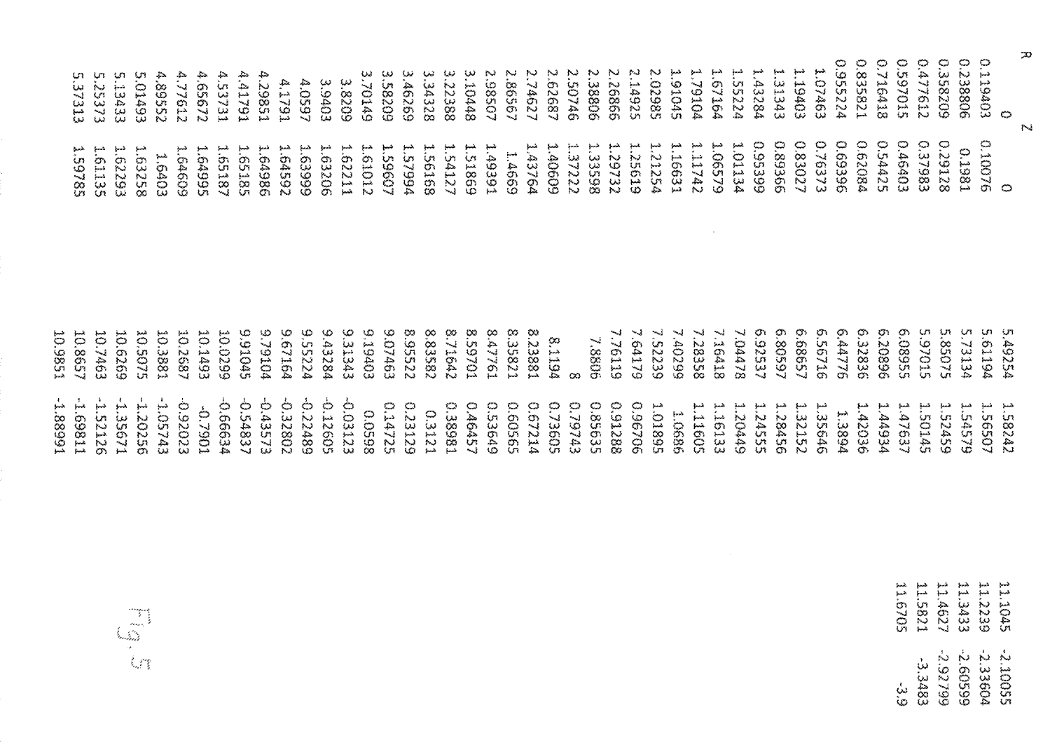

The front surface 51 of the inner optical lens 22 is achieved by rotating a convex-shaped curve about a center axis, where a peak of the convex shaped curve is offset from the center axis. FIG. 4 depicts a cross-sectional view of the inner optical lens 22 with the flange facing downward. A coordinate system of radius R and height Z is superimposed on the inner optical lens 22 with the origin of the coordinate system being at a center of the depression. FIG. 5 is a dataset of 100 points for the spline curve of the convex shaped curve using the R, Z coordinates. The units used are millimeters. However, the curve can be scaled up or down depending on the requirements of the particular implementation, such as the size of the outer optical lens 10.

FIG. 4 also shows surfaces S1-S5 of a particular embodiment of the light source 23 and the inner optical lens 22 in which the light source 23 includes an LED die and lens. The optical prescription for the FIG. 4 embodiment is as follows:

Optical prescription for Inside Lens

| | | Radius | | Distance | | |
|---|---|---|---|---|---|---|
| | | of cur- | Special | to next | | Clear |
| Surf. | | vature | surface | surface | | aperture |
| # | Description | (mm) | type | (mm) | Material | (mm) |
| S1 | Flange Base | — | | 0.50 | — | — |
| S2 | LED Die | — | | 1.45 | Silicone | 1.0 × 1.0 |
| | Top | | | | | |
| S3 | LED Lens | −1.45 | | 0.20 | — | 2.9 Φ |
| | Top | | | | | |
| S4 | R1 Inside | −1.65 | | 3.35 | Acrylic | 3.3 Φ |
| | Lens | | | | | |
| S5 | R2 Inside | — | Spline | — | — | 11.67 Φ |
| | Lens | | | | | |

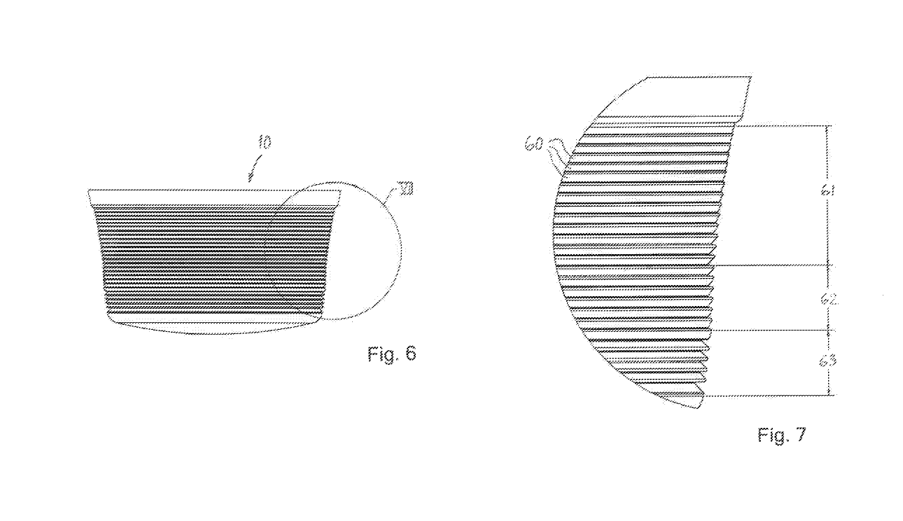

As shown in FIGS. 6 and 7, the outer optical lens 10 includes a plurality of ribs 60 arranged circumferentially. The ribs 60 are arranged in three zones 61, 62, 63. Each of the ribs has a facet to direct the irradiance received from the light source in a particular direction. The first zone directs light substantially horizontally, i.e., +/−4 degrees from horizontal, the second zone 62 directs light below horizontal to a predetermined perimeter on the ground, i.e., from −4 degrees to a 5 foot perimeter on the ground, and the third zone 63 directs light within the predetermined perimeter, i.e., within a 5 foot perimeter on the ground. In a preferred embodiment, the facets have radii of curvatures on their upper and lower ends so that they do not end abruptly. This facilitates manufacture and also diffuses the light to limit banding.

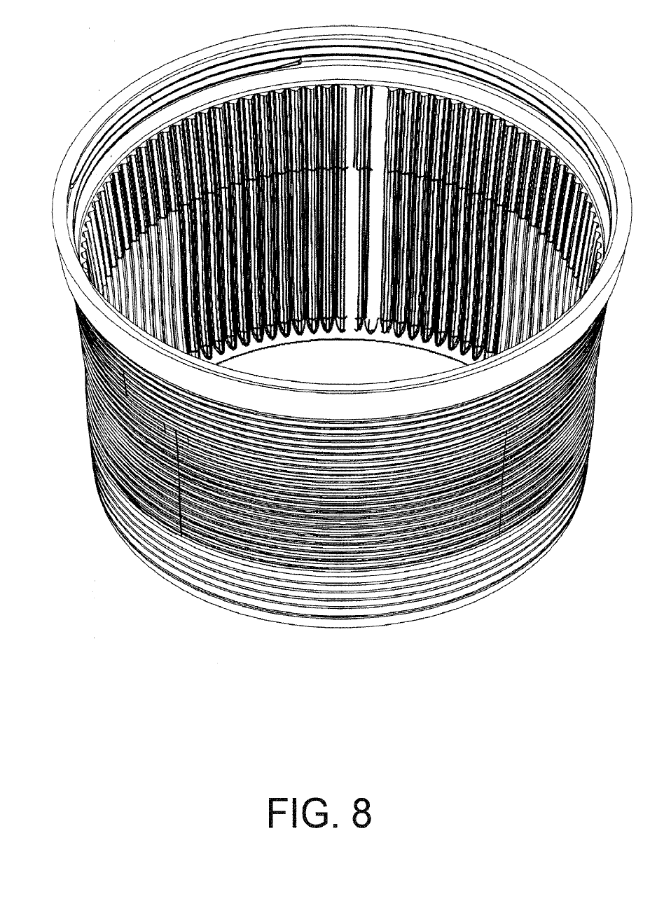

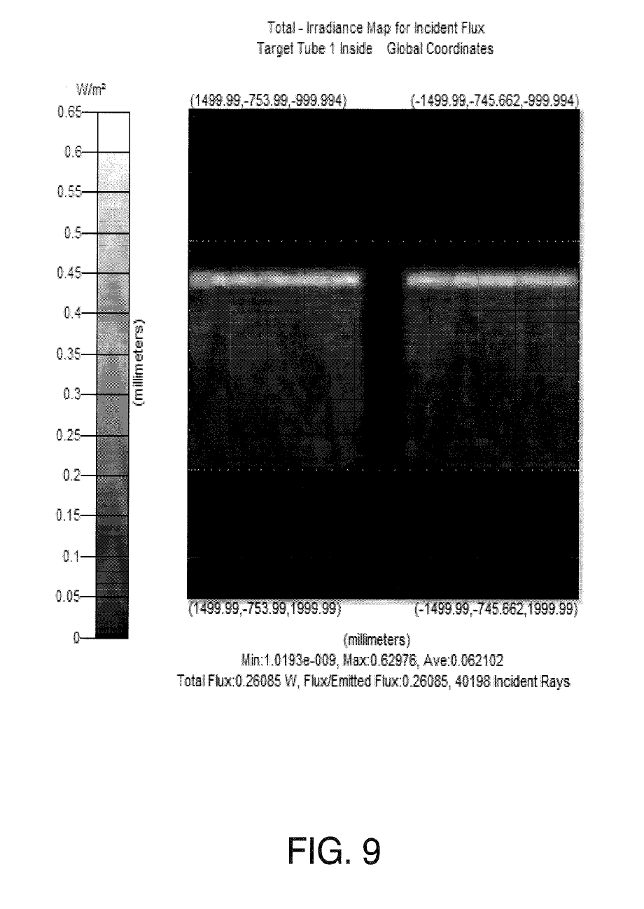

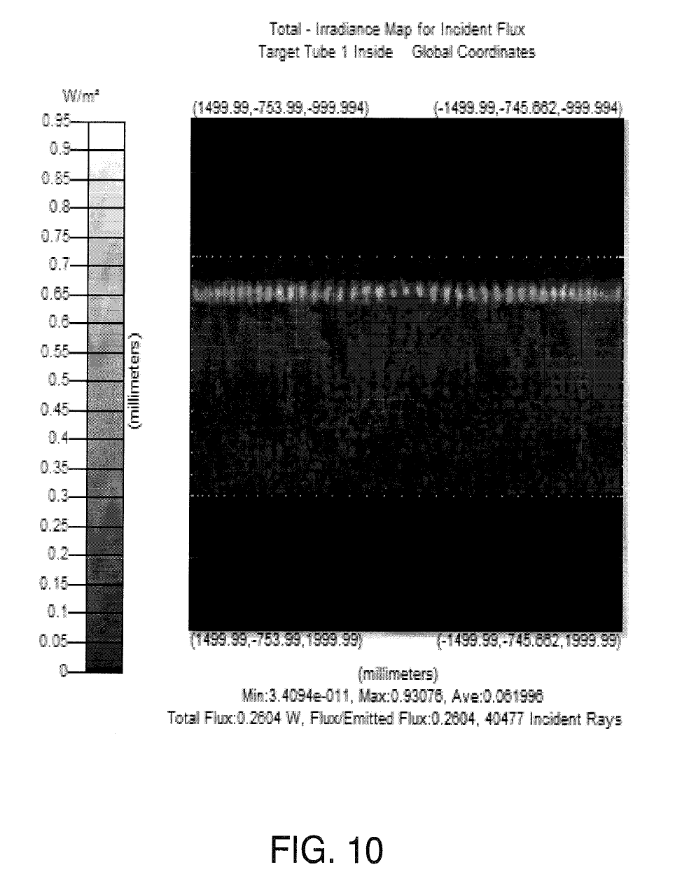

The inner side of the sidewalls 10b includes vertical ribs 65 as shown in FIG. 8. Because the brackets 38 are arranged on the outer side of the outer optical lens 10, they can create shadows. The vertical ribs help to avoid the shadows. FIG. 9 is an example of how the shadow would appear at about 5 feet from the light without the vertical ribs. The result of the vertical ribs is shown in FIG. 10 which shows the irradiance at 5 feet from the light.

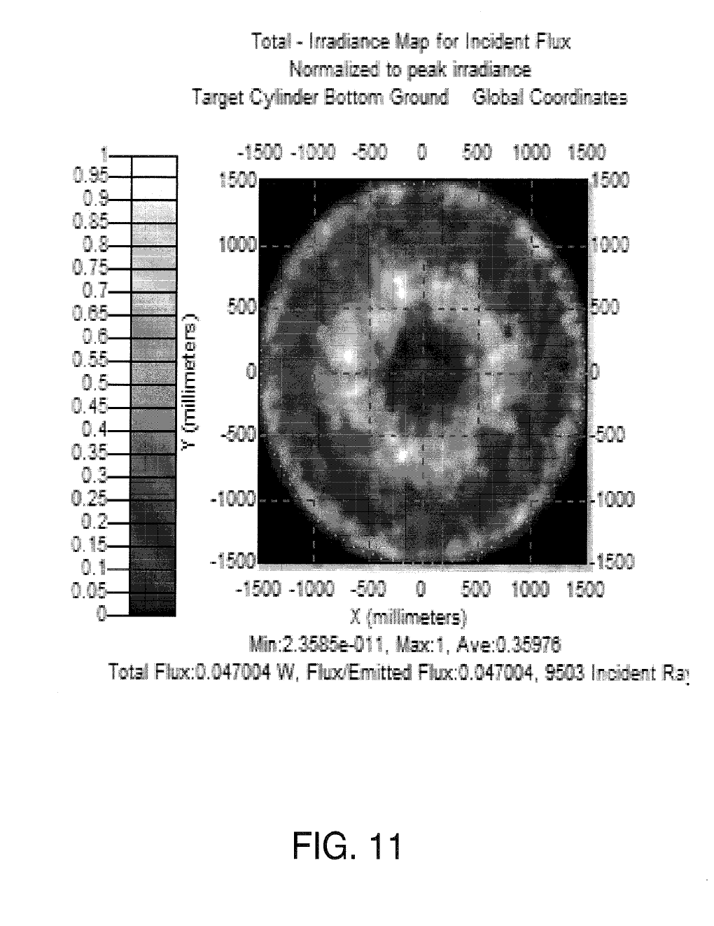

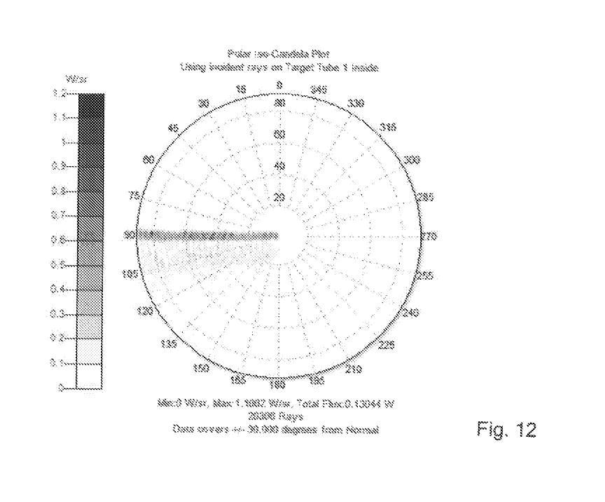

FIG. 11 is an irradiance pattern for zone 3. In a preferred embodiment, about 7% of the total energy is placed in this zone. FIG. 12 is a Candela plot which shows a high energy focus around the horizontal.

The following table shows irradiance in each of the zones.

| Simulation | Zone 1 | Zone 2 | Zone 3 | Lost |
|---|---|---|---|---|
| No Fixture | 36 | 36 | 8 | 20 |
| Fixture | 31 | 32 | 8 | 29 |

Thus, the piling light is about 80 percent efficient when removing the blocking effect of the support fixture. An additional 9 percent of the light is lost from the support fixture.

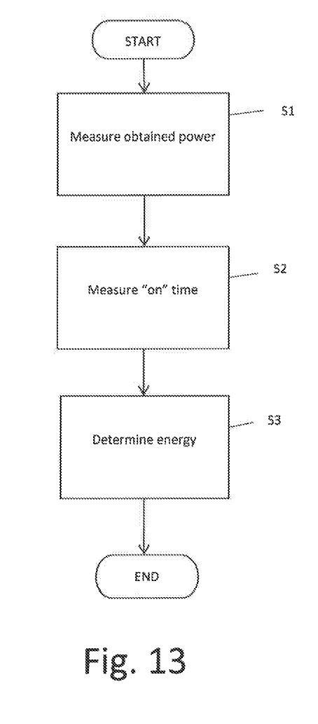

FIG. 13 shows a flow diagram depicting a further embodiment of the present invention. The main controller board 30 measures the power obtained by the solar panel and stored in the battery within a predetermined period, step S1. In a preferred embodiment the predetermined time period is 24 hours. The light source is turned on and off by the main controller board 30 in response to an ambient light detector, which may be mounted on the solar panel. In a further embodiment, the main controller board 30 also measures the time that the light is on, step S2, and may maintain an average over a predetermined time period, such as a week. The time that the light is required to be on is used with the information on the power obtained to determine the amount of energy to be delivered to the light source, step S3. For example, it may be determined that the energy deliver to the light should be 80% so that the stored energy will last for the entire period that the light is required to be on.

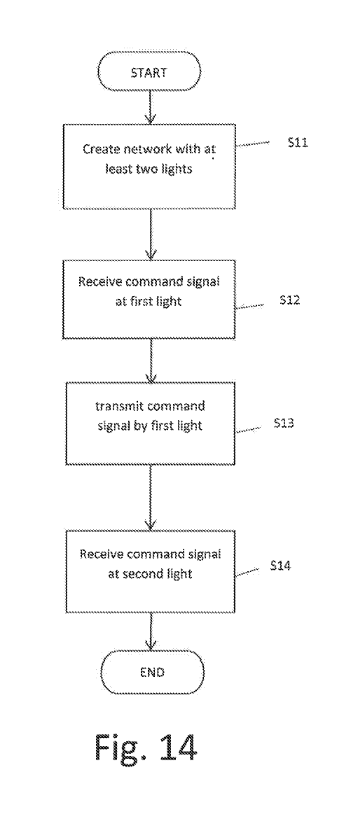

As stated above, the light may include a remote controller board 34, which allows a user to control a brightness level or to turn the light on and off via a remote controller. Additionally, or alternatively, the remote control board may include a transceiver. that cooperates with other lights to create a network. FIG. 14 is a flow diagram according to yet another embodiment in which the network is created between two lights, step S11. The network may be used to communicate when one of the lights turns on such that all of the lights turn on or off at the same time. For example, if a user with a remote controller sends a signal to turn on the lights, but at least some of the lights are too far to receive the signal directly, a first light in range of the remote will receive the command signal, step S12. The first light of the network will then communicate the fact that a turn on signal was received to at least a second light, step S13, in the network that did not receive the command signal directly from the remote control. The second light receives the command signal indirectly through the network, step S14. In that way all of the lights in one area can be controlled in unison, even if the remote controller signal does not reach all of the lights.

What is claimed is:

1. An outdoor light, comprising:
an outer optical lens having a circumferential sidewall and an open top, the sidewall having an outer side and an inner side, with a plurality of circumferential ribs arranged on the outer side;
a housing mounted at the top of the outer optical lens having a bottom facing an inside of the outer optical lens and a top facing away from the outer optical lens, with a control circuit mounted in the housing;
a light source mounted at the bottom of the housing with an inner optical lens disposed between the light source and the outer optical lens, the inner optical lens having a substantially convex outer surface with a central dimple.

2. The outdoor light of claim 1, wherein the outer surface of the inner optical lens is defined by a convex curve rotated about an axis with a peak of the convex curve being offset from the axis to form the dimple.

3. The outdoor light of claim 1, wherein the outer surface of the inner optical lens is configured to provide equal illumination of the inner side of the sidewall, whereby each rib of the outer optical lens receives the same lumens from the light source.

4. The outdoor light of claim 1, wherein the circumferential ribs of the outer optical lens are arranged in at least three zones of the outer optical lens, each zone of the at least three zones irradiating light in a different direction than the others of the at least three zones.

5. The outdoor light of claim 4, wherein the at least three zones include a first zone directing light substantially in a horizontal direction, a second zone directing light in a direction between horizontal and the ground, and a third zone directing light to the ground in a predetermined perimeter surrounding the outdoor light.

6. The outdoor light of claim 5, wherein the first zone directs light in the range +/−4 degrees from horizontal, the second zone directs light in a range from −4 degrees to the predetermined perimeter, and the third zone directs light within the predetermined perimeter.

7. The outdoor light of claim 4, wherein each of the circumferential ribs has a facet for directing the irradiated light, each facet beginning with a radius of curvature and ends with a radius of curvature, thereby facilitating manufacture and eliminating banding of irradiated light.

8. The outdoor light of claim 1, further comprising a solar panel arranged at the top of the housing and a battery and the control circuit arranged inside the housing, with a first heat sink disposed between the solar panel and the housing.

9. The outdoor light of claim 8, further comprising a mount including a base and at least three vertical brackets, wherein the first heat sink is connected to each of the vertical brackets, whereby heat generated by the solar panel and the housing is dissipated through the first heat sink and vertical brackets.

10. The outdoor light of claim 9, further comprising a second heat sink arranged between the light source and the housing, wherein the light source is mounted to the housing by the second heat sink.

11. The outdoor light of claim 9, wherein the housing, the inner optical lens, and the outer optical lens form an integral assembly supported by the vertical brackets via the first heat sink.

12. The outdoor light of claim 8, wherein the control circuit measures an amount of power obtained from the solar panel and stored by the battery in a predetermined period.

13. The outdoor light of claim 12, wherein the amount of power obtained is used to determine one of a turn on time of the light source, a turn off time of the light source, or an intensity of the light source.

14. The outdoor light of claim 13, wherein the control circuit further measures a length of a dark period from dusk until dawn to determine how long the light source is required to be turned on and controls an intensity of the light source based on the measured length and the measured amount of power.

15. The outdoor light of claim 1, further comprising a remote control circuit allowing a user to at least one of turn on the light source, turn off the light source, and to control the intensity of the light source.

16. The outdoor light of claim 1, further comprising a wireless transceiver allowing communication with other outdoor lights.

17. The outdoor light of claim 16, wherein the transceiver is connected to the control circuit.

18. A method of operating a plurality of outdoor lights, each having a control circuit for receiving command signals and a transceiver, the method comprising:
creating a network by communications between transceivers of at least first and second lights of said plurality of outdoor lights;
receiving a command signal at the first light;
transmitting the command signal from the transceiver of the first light; and
receiving the command signal by the second light from the first light.

19. A method of operating an outdoor light having a control circuit, a light source, a solar panel, and an energy storage unit, the method comprising:
measuring, by the control circuit, an amount of power obtained from the solar panel within a predetermined time period; and
determining, by the control circuit, at least one of a turn on time of the light source, a turn off time of the light source, or an intensity of the light source, based on the measured amount of power.

20. The method of claim 19, wherein the control circuit determines how long the light source is required to be turned on and controls the intensity of the light source based on the measured length and the measured amount of power.
